(19) United States
(12) Patent Application Publication
(10) Pub. No.: US 2003/0061137 A1
(43) Pub. Date: Mar. 27, 2003

(54) Settlement of transactions subject to multiple pricing plans

(76) Inventors: Yiu Kau Leung, Morganville, NJ (US); John Davis Price, Colts Neck, NJ (US); Brion Feinberg, Morganville, NJ (US)

Correspondence Address: WOODCOCK WASHBURN LLP, ONE LIBERTY PLACE, 46TH FLOOR, 1650 MARKET STREET, PHILADELPHIA, PA, 19103, US

(21) Appl. No.: 10/225,224

(22) Filed: Aug. 21, 2002

Related U.S. Application Data
(60) Provisional application No. 60/313,968, filed on Aug. 21, 2001.

(51) Int. Cl. G06F 17/60

(52) U.S. Cl. 705/35

(57) ABSTRACT

The invention includes a method, system, and computer-readable medium having computer-executable instructions for rating a transaction. The inventive method includes processing a transaction, where the transaction is processed when a service is provided from a service provider to a service consumer, accessing via a computer network multiple pricing plans related to the transaction, and rating the transaction in accordance with the multiple pricing plans. The method further may include receiving output states from at least one pricing plan. The rating may be accomplished within one pricing plan, or within a group of pricing plans.

### CROSS REFERENCE TO RELATED APPLICATIONS

This application claims priority under 35 U.S.C. §119 (e) from provisional application No. 60/313,968 filed Aug. 21, 2001. The provisional application 60/313,968 is incorporated by reference herein, in its entirety, for all purposes.

### TECHNICAL FIELD

The invention relates generally to the processing of data, and more particularly to efficiently and generically aggregating data available on a communication network and billing/paying multiple parties for access to the content of the aggregated data.

### BACKGROUND OF THE INVENTIOIN

Recently, the collection and processing of data transmitted over communication networks, like the Internet, has moved to the forefront of business objectives. In fact, with the advent of the Internet, new revenue generating business models have been created to account for the consumption of content received from a data network (i.e., content-based billing). For example, content distributors, application service providers (ASPs), Internet service providers (ISPs), and wireless Internet providers have realized new opportunities based on the value of the content that they deliver. As a result of this content-billing initiative, it has become increasingly important to resolve intelligently and flexibly the corresponding transactions according to the business needs of the customer.

Often, even in traditional commerce streams, there are many different participants between the maker and the consumer of the good. Some of these so called “middlemen” simply may facilitate access to the good, while others may add useful characteristics to the good. This is especially true in a distributed network environment, like the Internet, that impose additional burdens on capturing the transaction process because of the unlimited number of data sources and the correspondingly unlimited number of data types. As a result, adequately describing the transacting of the goods and services in such an environment, or even across any of the traditional environments requires a technique that is capable of understanding and processing the participants and the various types of data.

To date, resolving the characteristics of a transaction has been accomplished over data-specific environments using certain application-specific (i.e., “non-generic”) methods. For example, a typical telephone bill captures the characteristics of a voice-based telecommunications transaction. In particular, the participants may be identified as the party initiating the call (ie., the “calling party” telephone number), the party receiving the call (i.e., the “called party” telephone number), and one or more parties connecting the communication (i.e., the “local” or “long distance carrier”). This simple example adequately captures all of the necessary aspects of the telephone call to properly account for the transaction by requiring payment from certain parties (e.g., the calling and/or the called party) to certain other parties (e.g., the local and/or long distance carrier). While these “hard-coded” transaction resolution techniques are sufficient to accommodate only specific environments involving well-defined participants, they are correspondingly too rigid to efficiently satisfy the ever-changing face of a communication network like the Internet. Also, these “hard-coded” techniques are too specific to operate across the many and varied transaction environments that exist throughout the business world.

Therefore, there exists a need to provide a flexible technique that can capture and resolve transactions of any type and involving any participants without requiring modification of the technique for each type. Such a technique would serve to accommodate multi-faceted network environments like the Internet, as well as to provide a single solution that would apply to any business environment.

### SUMMARY OF THE INVENTION

The invention includes a method, system, and computer-readable medium having computer-executable instructions for rating a transaction. The inventive method includes processing a transaction, where the transaction is processed when a service is provided from a service provider to a service consumer, accessing via a computer network multiple pricing plans related to the transaction, and rating the transaction in accordance with the multiple pricing plans. The method further may include receiving output states from at least one pricing plan. The rating may be accomplished within one pricing plan, or within a group of pricing plans. Also, accessing the multiple pricing plans may be accomplished via interconnected building blocks located within each of the pricing plans. The method also may include a revenue fold that summarizes the output of multiple pricing plans, including child and parent accounts. Selection of the appropriate child accounts may be a function of end dates that are within a parent account's time period. The method further may pool revenue/usage data as a function of billing cycles, and update the pooled revenue/usage data by summing the values of data from selected account plan periods. Values of the pooled revenue/usage data may be obtained via a building block. The inventive method also may determine a commission, wherein the commission is a credit given to an account.

### BRIEF DESCRIPTION OF THE DRAWINGS

Other features of the invention are further apparent from the following detailed description of the embodiments of the invention taken in conjunction with the accompanying drawings, of which:

FIG. 1 is a block diagram of a system for analyzing content transmitted over a communication network, according to the invention;

FIG. 2 is a block diagram further describing the components of the system described in FIG. 1;

FIGS. 3A and 3B provide a flow diagram further detailing the operation the system described in FIG. 1;

FIG. 4 provides a block diagram of the system described in FIG. 1, providing greater detail of a configuration and operation of a transaction layer;

FIGS. 5A and 5B provide a flow diagram of a method for identifying the characteristics of a transaction, according to the invention;

FIG. 6 is a block diagram further detailing the operation and configuration of the transaction layer, according to the invention;

FIG. 7 is a flow diagram that details the operation and configuration of the transaction layer of transaction layer, according to the invention;

FIG. 8 illustrates a sample settlement scenario for settling the fees associated with the download of certain content;

FIG. 9 illustrates a general system description of settlement technologies useful in accordance with the invention to accommodate multiple aggregation of usage, multiple ownership of content, and multiple settlement options;

FIG. 10 illustrates a settlement example for digital music downloaded by a consumer from an on-line music club that implements a pricing plan to the consumer and a publisher payment plan using the settlement techniques of the invention;

FIG. 11 illustrates a transaction pricing usage based settlement model for use in settling low volume, high value transactions;

FIG. 12 illustrates a billing cycle pricing, usage based settlement model for use in settling high volume, low value transactions;

FIG. 13 illustrates a revenue sharing settlement using folds in accordance with a first embodiment of the invention;

FIG. 14 illustrates a revenue sharing settlement using revenue/usage pools in accordance with a second embodiment of the invention;

FIG. 15 illustrates a revenue pool contribution example for the embodiment of FIG. 14;

FIG. 16 illustrates a revenue pool accessor example for the embodiment of FIG. 14;

FIG. 17 illustrates a revenue sharing settlement using commissions in accordance with a third embodiment of the invention;

FIG. 18 provides an example of computing revenue fold;

FIG. 19 illustrates how accounts and pools with different billing cycles contribute to and access from pool instances; and

FIG. 20 provides an example of how an account with billing period ending will get one commission from account.

### DETAILED DESCRIPTION OF THE INVENTION

### System Overview

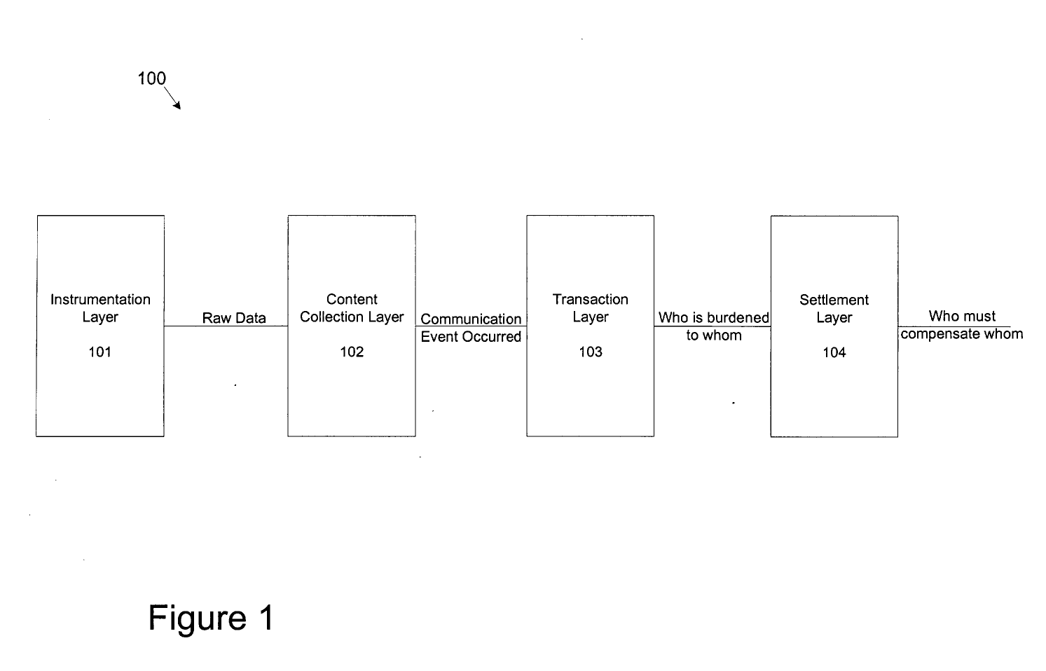

FIG. 1 is a block diagram of a system 100 for analyzing content transmitted over a communication network. Although the following description will be discussed in the context of collecting, processing and billing for data transmitted over the Internet, it should be appreciated that the invention is no so limited. In fact, the invention may be applied to any type of network, including a private local area network, for example. Also, the invention may be used for purposes other than billing for the usage of content. For example, the invention may be used to analyze the type of data transmitted over a particular network, or to determine the routing patterns of data on a network. Furthermore, the invention may be used to facilitate the intelligent collection and aggregation of data relevant to a particular industry. In addition, the invention may be used to track specific Internet protocol (IP) network resources and to detect fraud, for example.

In addition, it should be appreciated that the term “content” may be defined as data that is transmitted over the network. In the context of the Internet, content may include .mp3 files, hypertext markup language (html) pages, videoconferencing data, and streaming audio, for example. The terms “content provider” and “customer” will be used throughout the description as well. Content provider may refer to the primary creator or provider of the content, while customer is the primary recipient of the content. Both the producer and customer may be a human or a computer-based system.

As shown in FIG. 1, an instrumentation layer 101 provides raw data to a content collection layer 102. Instrumentation layer 101 may consist of various data sources, for example, network routers. The network routers may provide information regarding the various types of routed data, including for example, data format, originating Internet protocol (IP) address, and destination IP address. One example of such information is Cisco System's NetFlow™.

Content collection layer 102 collects information about the delivery of the content, as well as the substance of the content itself. Content collection layer 102 also may sort, filter, aggregate, and store the content according to the particular needs of the end user. In effect, content collection layer is responsible for extracting meaningful information about IP traffic, and so it is provided with an understanding of the data sources in instrumentation layer 101. Content collection layer 102 also may transform the data from the plurality of sources in instrumentation layer 101 into standard formats for use in a transaction layer 103.

Content collection layer 102 is in communication with transaction layer 103. Generally, content collection layer 102 reports to transaction layer 103 that a relevant communication event has occurred and should be considered by the remainder of system 100. A communication event may be defined as any transfer of data between systems. Transaction layer 103 captures the predetermined agreements among all of the parties involved in system 100 regarding the value of the transferred content, as well as the value added by each of the individual parties in transferring such content. Therefore, transaction layer 103 is charged with understanding the nature of the parties, as well as the understanding the actions that one or more parties perform and the influence of such action on the respective parties.

Transaction layer 103 is in communication with a settlement layer 104. Settlement layer 104 captures the operations that are necessary to understand the significance of the transaction defined by transaction layer 103. For example, settlement layer 104 may rate a particular transaction by assigning a monetary value to the transaction. Settlement layer 104 also may divide the burdens and benefits of the monetary value among the relevant parties. In this way, settlement layer 104 ensures that certain parties receive a particular portion of the payment made by the other parties. Settlement layer 104 also may be responsible for delivering this burden and benefit information to the appropriate parties with the appropriate identifiers (e.g., account numbers). As will be explained in more detail below, the present invention is directed to operations of the settlement layer 104.

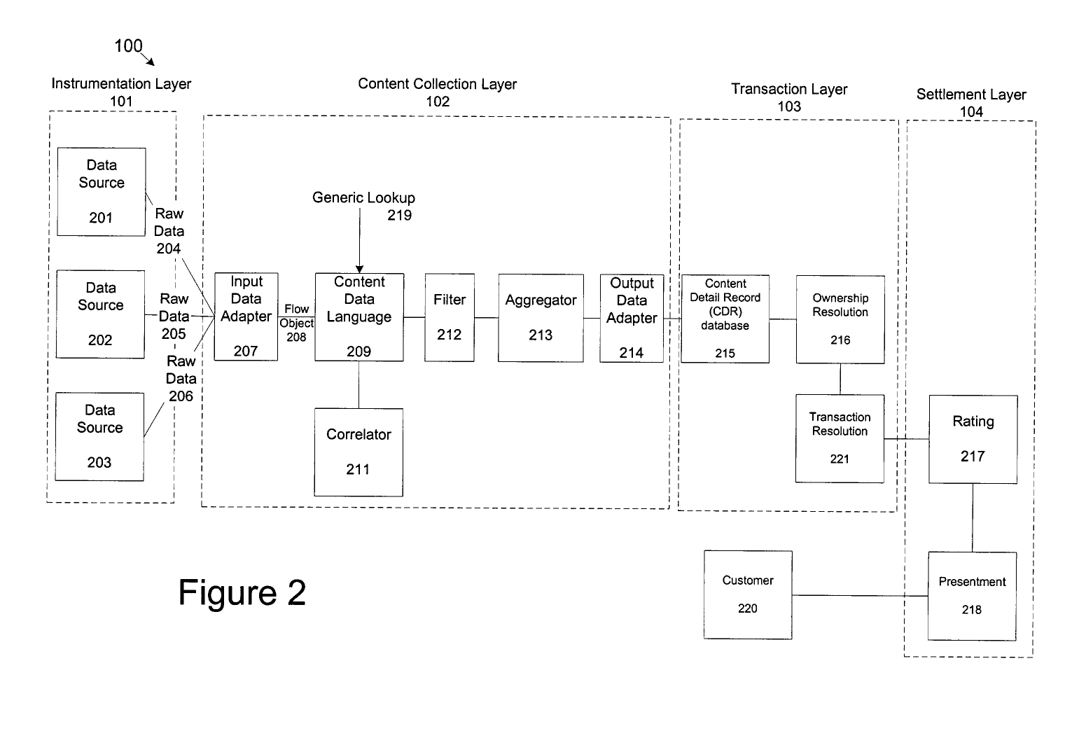

FIG. 2 is a block diagram further describing the components of system 100. As shown in FIG. 2, instrumentation layer 101 includes data sources 201-203 that each provide raw data 204-206, respectively, to collection layer 102. As discussed, data sources 201-203 may include various internetworking devices like routers, bridges, and network switches. Data sources 201-203 provide raw data to an input data adapter 207. Accordingly, input data adapter 207 understands the operation of and the data provided by data sources 201-203. Although one input data adapter is shown in FIG. 2, it should be appreciated that more than one input data adapter may be used in system 100. For example, each data source may have a dedicated input data adapter.

Input data adapter 207 understands the incoming data and extracts the data into the appropriate fields. This field-delimited data, called flow objects 208, are sets of attributes. The attributes may be any characteristics that are provided by, or can be derived from, raw data 204-206 provided by data sources 201-203, respectively. For example, flow objects 208 may include a set of attributes describing the source and destination, including source IP address, destination IP address, source interface, and destination interface. Because input data adapter 207 is charged with understanding raw data 204-206 from data sources 201-203, as well as the required flow objects 208 of system 100, it is capable of transforming the raw data to the flow objects, where the flow objects may all be of a standard format.

Input data adapter 207 provides flow objects 208 to a content data language 209. Content data language 209 may transform the attributes in flow objects 208 into other attributes that are desired by a particular customer. For example, content data language 209 may derive a network identifier attribute that is not readily available from a data source, from a source address attribute and a destination address attribute that are provided by flow object 208 attributes from input data adapter 207. This derivation may be based on a customer's desire to determine which network conveyed the transaction between the source and the destination. Therefore, following this example, content data language 209 will know to extract the source address attribute and the destination address attribute from flow objects 208.

Content data language 209 may perform other functions as well. For example, content data language 209 may perform a generic lookup function 219 that is built into content data language 209. Generally, generic lookup 219 describes a technique for mapping any number of attributes to any number of other derived attributes. For example, generic lookup 219 may be used to map a unique resource locator (URL) attribute to a particular content-type attribute.

Content data language 209 also is in communication with a correlator 211. Generally, correlator 211 connects the many daily network content events from various network devices, like routers for example. Often, the connected data may come from distinctly different data sources at distinctly unrelated times. Correlator 211 allows this data to be intelligently connected to each other, regardless of how different the sources or of how disparate the time received. For example, a Netflow™ enabled router and a Radius™ enabled network access switch may each provide certain data that is relevant to one particular transaction. However, because portions of the data come from different devices, the data may arrive at system 100 at different times, and in different formats. Also, because each provides data that is necessary to complete one transaction, the data from each cannot be considered separately. Correlator 211 allows this data to be intelligently grouped regardless of the format of the data or of the time the data pieces are received.

Furthermore, correlator 209 may rearrange the order of the received flow objects 208 to suit the needs of the remainder of system 100. By performing such correlation without having to first store all of the data on a disk (e.g., a database), significantly faster processing is achieved. Correlator 209 may perform this correlation in real-time, for example.

Although system 100 has been described using content data language 209 and correlator 211, it should be appreciated that flow objects 208 may proceed directly to a filter 212, if no correlation is required and if no attribute derivation is required, for example. Filter 212 analyzes flow objects 208 to ensure that the provided attributes are desired by system 100. If flow objects 208 are not needed (i.e., a mismatch), filter 212 may prevent flow objects 208 from passing to an aggregator 213. Also, although filter 212 has been shown as a separate device in system 100, it should be appreciated that the functionality of filter 212 may be incorporated into aggregator 213.

Filter 212 passes the matching flow objects to aggregator 213. Aggregator 213 may provide additional filtering and classification of the multitude of daily network content transactions, based on user criteria. Aggregator 213 may perform such filtering and classification in real-time. Aggregator 213 provides the filtered and classified information to an output data adapter 214. Output data adapter 214 may convert the data from aggregator 213 into one or more content detail records for storage in CDR database 215. Therefore, CDR database 215 stores a complete description of a content event.

Transaction layer 103 includes CDR database 215, an ownership resolution component 216, and a transaction resolution component 221. CDR database 215 passes the CDR onto ownership resolution component 216. A proper accounting of a communication event, for any purpose including billing, requires both identifying the participants and defining the relationships among those participants. These tasks are accomplished by ownership resolution component 216 and transaction resolution component 221.

Ownership resolution component 216 serves to define the participants of the communication event. In particular, because raw data 204-206 may not provide sufficient “ownership” data relating to the parties involved in the content transaction, such “ownership” data must be provided by system 100 to properly account for the entire transaction. Ownership resolution component 216 operates to provide such ownership-based data to system 100.

Ownership resolution component 216 is in communication with transaction resolution component 221. Transaction resolution component 221 serves to capture the predetermined relationships and/or agreements among the parties defined by ownership resolution component 216 regarding the value of the transferred content, as well as the value added by each of the individual parties in transferring such content. Such predetermined relationships may be previously agreed upon by the participants, or may be created and agreed upon with the implementation of system 100. Therefore, transaction component 103 understands the nature of the parties, the actions that one or more parties perform, and the influence of such action on the respective parties.

Transaction component 216 provides the transaction information to a rating component 217. Rating component 217 provides a weight or significance (e.g., a price) to the transaction, so as to provide a tangible value to the transaction. Rating component 217 may make this determination based on various metrics including the type of the content, the quantity of content consumed, the place and time delivered, or the quality of the content, for example. Therefore, rating component 217 allows system 100 to provide some contextual value, indicting the significance or relevance that certain content or information has to the individual customer.

Rating component 217 provides the rated transaction to a presentment component 218. Presentment component 218 may provide the capability for a customer 220 to view their real-time billing information, for example, over the network. Presentment component 218 also may attach relevant identifiers to the bill (e.g., account numbers, etc.).

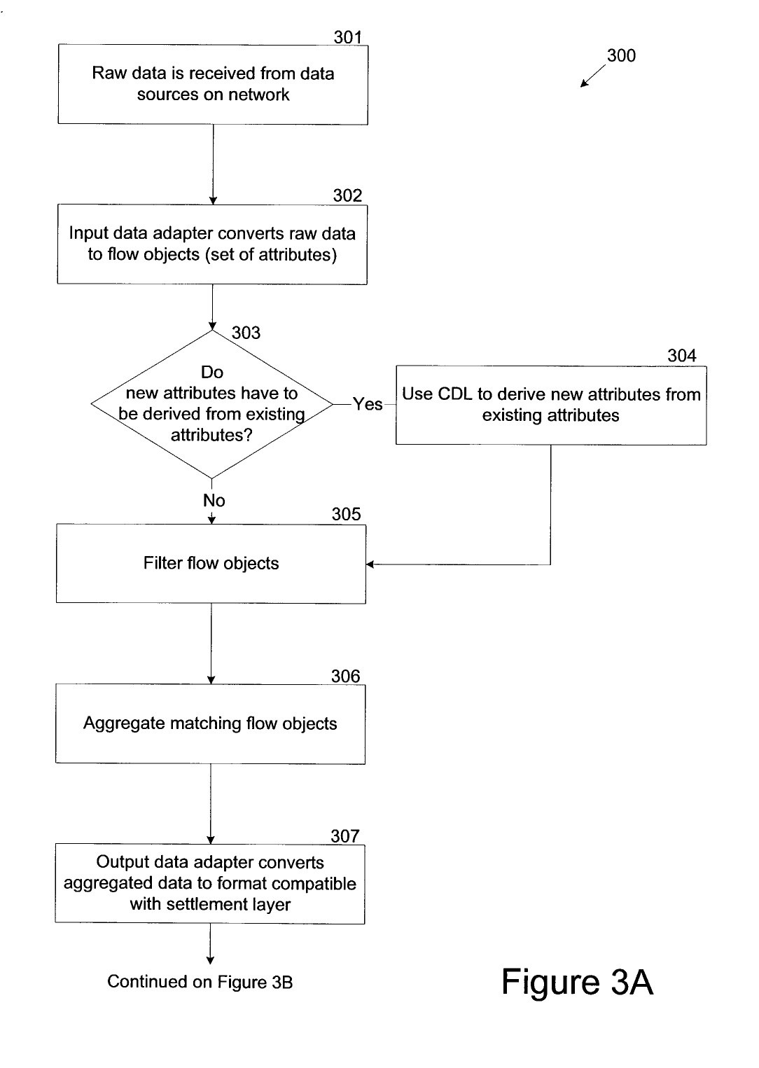

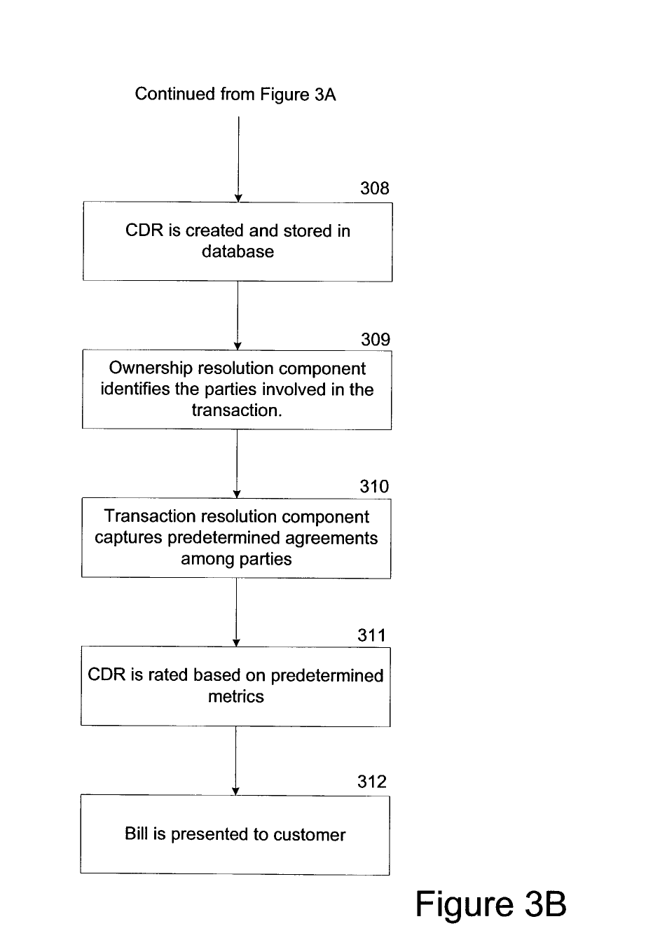

FIGS. 3A and 3B provide a flow diagram further detailing the operation 300 of system 100. As shown in FIG. 3A, in step 301, raw data 204-206 is received from data sources 201-203. In step 302, input data adapter 207 converts raw data 204-206 to flow objects 208, where flow objects 208 are sets of attributes, determined from raw data 204-206. In step 303, it is determined whether there is a need to derive new attributes from the existing attributes found in flow objects 208. If there is such a need, in step 304, CDL 209 is used to derive new attributes from existing attributes. Also, as discussed above, attributes may be correlated by correlator 211.

In step 305, flow objects 208 are filtered by filter 212. In step 306, the matching flow objects (i.e., those passed by filter 212) are further filtered and classified by aggregator 213. In step 307, output data adapter 214 converts the data aggregated by aggregator 213 to a format compatible with transaction layer 103.

As shown in FIG. 3B, in step 308, output adapter 214 may format the aggregated data into one or more content data records for storage in CDR database 215. In step 309, ownership resolution component 216 identifies the parties involved in the transaction. In step 310, transaction resolution component 221 captures the predetermined agreements among the parties, as well as the value added by each of the individual parties. In step 311, the CDR is rated based on predetermined metrics (e.g., time of transmission, quality of content). In step 312, a bill is presented to the customer.

### Content Transaction Layer

A transaction, including a business transaction for example, may be any activity between two or more participants that affects certain parties. The affected parties may be considered the participants to the transaction, although parties and participants may be mutually exclusive entities. It should be appreciated that the terms “parties” and “owners” may be used interchangeably throughout. Also, a transaction may include one or more events, where an event may be some action (e.g., the transfer of a service or good) that the participants conduct with each other. Such events may be the exchange of data over a communication network, for example. Also, it should be appreciated that the same event or action may take place in any direction (e.g., from party A to party B or from party B to party A). The “subject” of the action is the party who performs the activity, while the “object” of the action is the party who is affected or influenced in any way by the action.

Transaction layer 103 is responsible for capturing the characteristics of the transaction, including the parties, participants, subject, object, event/action type, direction of the action, for example. The scope of the characteristics captured by transaction layer 103 will vary with the nature of instrumentation layer 101, the capability of content collection layer 102, and the requirements of settlement layer 104. Generally, transaction layer 103 captures the predetermined agreements among all of the parties involved in system 100 regarding the value of the transferred content, as well as the value added by each of the individual parties in transferring such content. Therefore, transaction layer 103 is charged with understanding the nature of the parties, as well as the understanding the actions that one or more parties perform and the influence of such action on the respective parties.

Transaction layer 103 includes CDR database 215, an ownership resolution component 216, and a transaction resolution component 221. CDR database 215 is a data store that holds each CDR for further processing by ownership resolution component 216 and transaction resolution component 221. In the context of a billable electronic business transaction, a proper accounting of a communication event, for any purpose including billing, requires both identifying the participants and defining the relationships among those participants. As discussed, ownership resolution component 216 serves to define the participants of the communication event, while transaction resolution component 221 serves to capture the predetermined relationships and/or agreements among the parties defined by ownership resolution component 216.

Transaction layer 103 is generic in that it operates without requiring an understanding of instrumentation layer 101 and content collection layer 102. Instead, transaction layer 103 takes the relevant characteristics of the transaction provided by instrumentation layer 101 and content collection layer 102, and selects and generates those characteristics required by settlement layer 104.

Although the operation of transaction layer 103 will be described in the context of an electronic event over a communication network for the purposes of billing for the event, it should be appreciated that the invention is not so limited, but is so described the purpose of clarity. For example, it should be appreciated that the invention may include functions other than billing, including security, network capacity planning, and content monitoring, for example. Also, the generic techniques described may be applied beyond the context of an electronic event over a communication network.

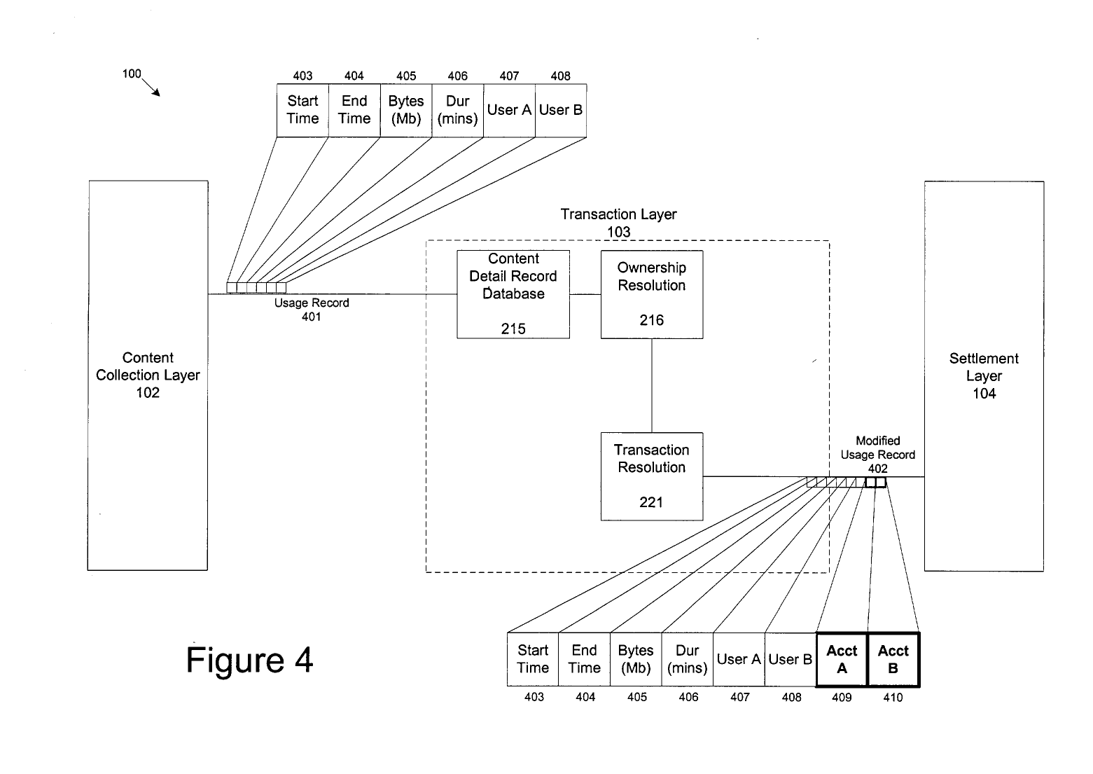

FIG. 4 provides a block diagram of system 100 providing greater detail of the configuration and operation of transaction layer 103. As shown in FIG. 4, content collection layer 102 provides a usage record 401 to transaction layer 103. A series of fields 403-408 comprise usage record 401. Although fields 403-408 will be identified by certain labels for the purpose of clarity, it should be appreciated that fields 403-408 may identify any of the many possible characteristics of the transaction.

In the example provided by FIG. 4, fields 407 and 408 identify the parties or participants to the transaction. In particular, field 407 identifies “User A” and field 408 identifies “User B.” User A may be the subject party and User B may be the object party. For example, in the context of a telecommunication event, User A may be the “calling” party and User B may be the “called” party. Field 405 and field 406 identify a measurable quantity of the event. In particular, following the example of the telecommunications event, field 405 identifies a duration (in minutes) of the event and field 406 identifies the quantity of data exchanged during the event (in megabytes). Field 403 and field 404 may identify a “start time” and an “end time,” respectively, of the communication event.

Although fields 403-408 provide just one example, in any case, it should be appreciated that user record 401 will include certain characteristics provided by instrumentation layer 101 and/or derived by content collection layer 102. These characteristics typically are provided to transaction layer 103 because they have some particular significance to identifying the characteristics necessary to allow settlement layer 104 to provide some accounting of the transaction. Therefore, usage record 401 may not necessarily include all of the characteristics provide by instrumentation layer 101 and/or derived by content collection layer 102, because certain characteristics may not relevant to the settlement of the transaction (e.g., network type). Yet, usage record 401 will include those available characteristics that pertain to permitting settlement layer 104 to properly account for the transaction.

Once usage record 401 passes through transaction layer 103, a modified usage record 402 may be provided to settlement layer 104. Modified usage record 402 may be modified by transaction layer 103 to include additional details of the transaction event required by settlement layer 104 and/or required by the customer's system to which the usage record applies (e.g., a usage billing system). As shown for modified usage record 402, an account A field 409 and an account B field 410 may be added to further identify the transaction. In one example, account A field 409 may include an alphanumeric designator that identifies the account number that has been assigned by the customer's billing system for User A. In the context of the telecommunications system, account A field 409 may hold User A's ten-digit home telephone number, for example.

In any case, the components of transaction layer 103 operate to identify these additional fields, based on the requirements of the customer's system and of settlement layer 104. In particular, ownership resolution component 216 operates to ensure that the necessary participants or parties to the transaction are identified, while transaction resolution component 221 operates to ensure that the relationships among the parties or participants are identified.

Identification of the relevant entities and their relationships may be accomplished using “lookups” in data stores located within ownership resolution component 216 and transaction resolution component 221, for example. For example, a data table may have a “User” data field and an associated “Account” data field. When User A is received by ownership resolution component 216, it will conduct a lookup in the data table and identify Account A as the appropriate account associated with User A. Also, transaction resolution component 221 may have a data table that permits a lookup of the relationship between User A and User B, identified in usage record 401. For example, upon receiving field 407 designating User A and field 408 designating User B, transaction resolution component 221 may conduct a lookup of an algorithm that identifies the appropriate burdens and benefits (e.g., debit and credit of money) assigned to each of the users with respect to each other.

It also should be appreciated that transaction layer 103 may not provide additional characteristics to usage record 401, as described but may select the relevant characteristics (i.e., those characteristics needed by settlement layer 104) from the characteristics made available by instrumentation layer 101 and/or derived by content collection layer 102. In fact, usage record 401 may include all of the necessary characteristics to properly account for the transaction. In this case, ownership resolution component 216 and transaction resolution component 221 select the relevant characteristics from the available characteristics. As will be explained in more detail below, the information added to the usage record 402 may also constitute pricing plans and the settlement layer may be configured to handle more sophisticated settlement strategies involving multiple parties and multiple pricing plans over a multiplicity of noncontiguous time periods.

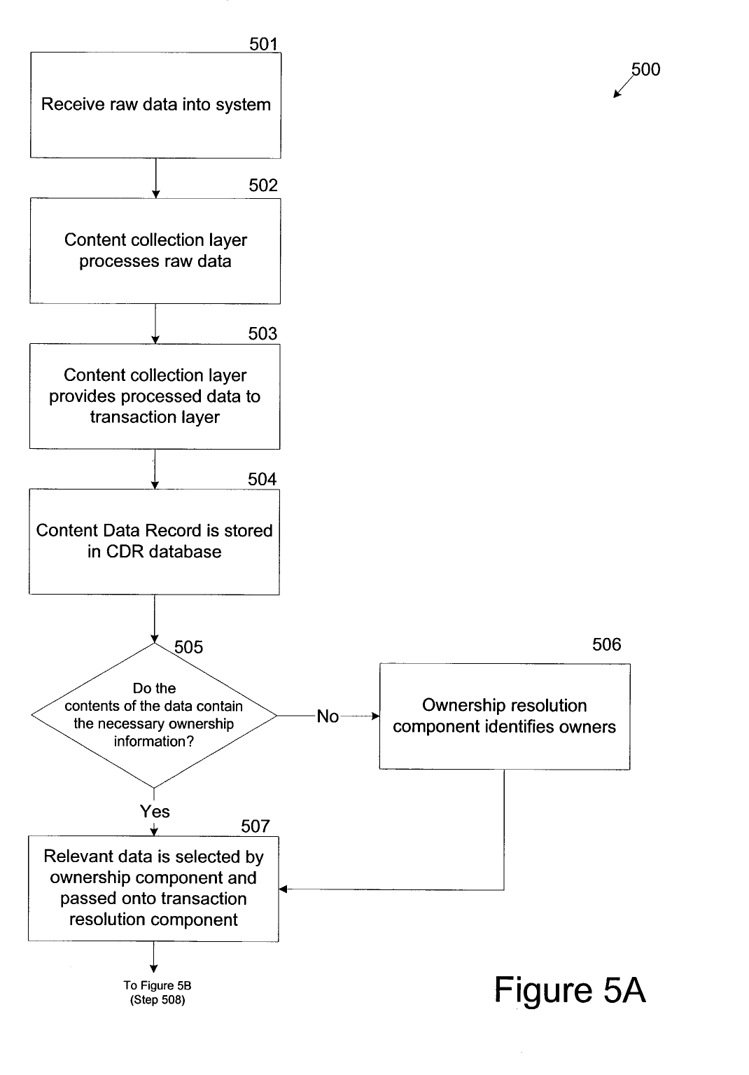

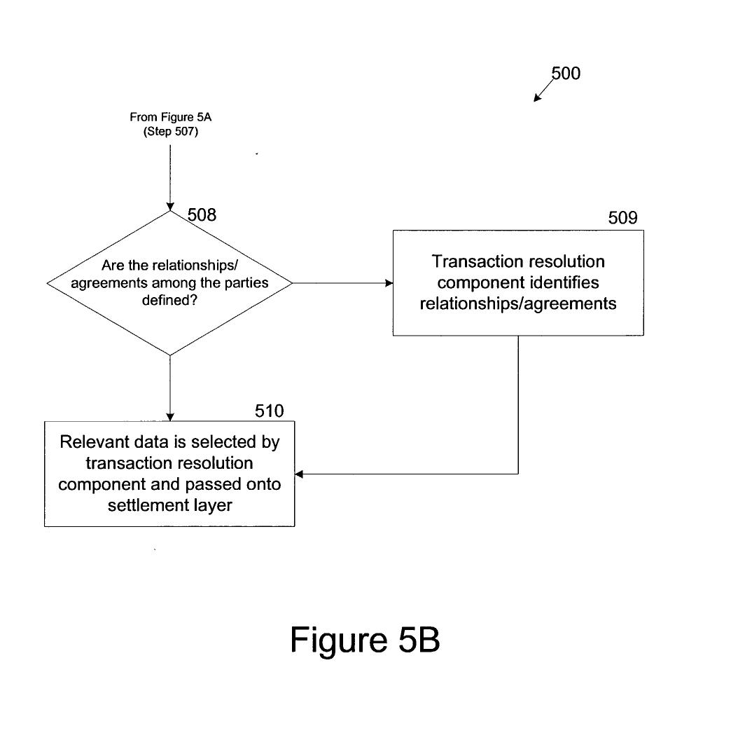

FIGS. 5A and 5B provide a flow diagram of a method 500 for identifying the characteristics of a transaction using system 100. As shown in FIG. 5A, in step 501, raw data 204-206 is received into system 100. Raw data 204-206 includes certain characteristics provided by data sources 201-203, respectively, in instrumentation layer 101. In step 502, content collection layer 102 processes (e.g., aggregates, correlates and filters) raw data 204-206. In step 503, content collection layer 102 provides the processed data to CDR database 215 in transaction layer 103. CDR database 215 stores the data for further processing by transaction layer 103.

In step 505, it is determined whether the contents of the data provided to transaction layer 103 already include the needed ownership data. If the data includes the needed ownership data, the relevant data is selected by ownership resolution component 216 and provided to transaction resolution component 221, in step 507. If, on the other hand, the data provided to transaction layer 103 does not already include the needed ownership data, the required data is identified (e.g., using database lookups) by ownership resolution component 216, in step 506. Once ownership resolution component 216 identifies the required ownership data, the relevant data is selected by ownership resolution component 216 and provided to transaction resolution component 221, in step 507.

As shown in FIG. 5B, in step 508 it is determined whether the contents of the data provided to transaction layer 103 already include the needed relationship data (i.e., data defining the burdens and benefits encountered by the parties/participants to the transaction). If the data includes the needed relationship data, the relevant data is selected by transaction resolution component 221 and provided to settlement layer 104, in step 510. If, on the other hand, the data provided to transaction layer 103 does not already include the needed relationship data, the required data is identified (e.g., using database lookups) by transaction resolution component 221, in step 509. Once ownership resolution component 216 identifies the required ownership data, the relevant data is selected by ownership resolution component 216 and provided to transaction resolution component 221, in step 510.

### Ownership and Transaction Resolution

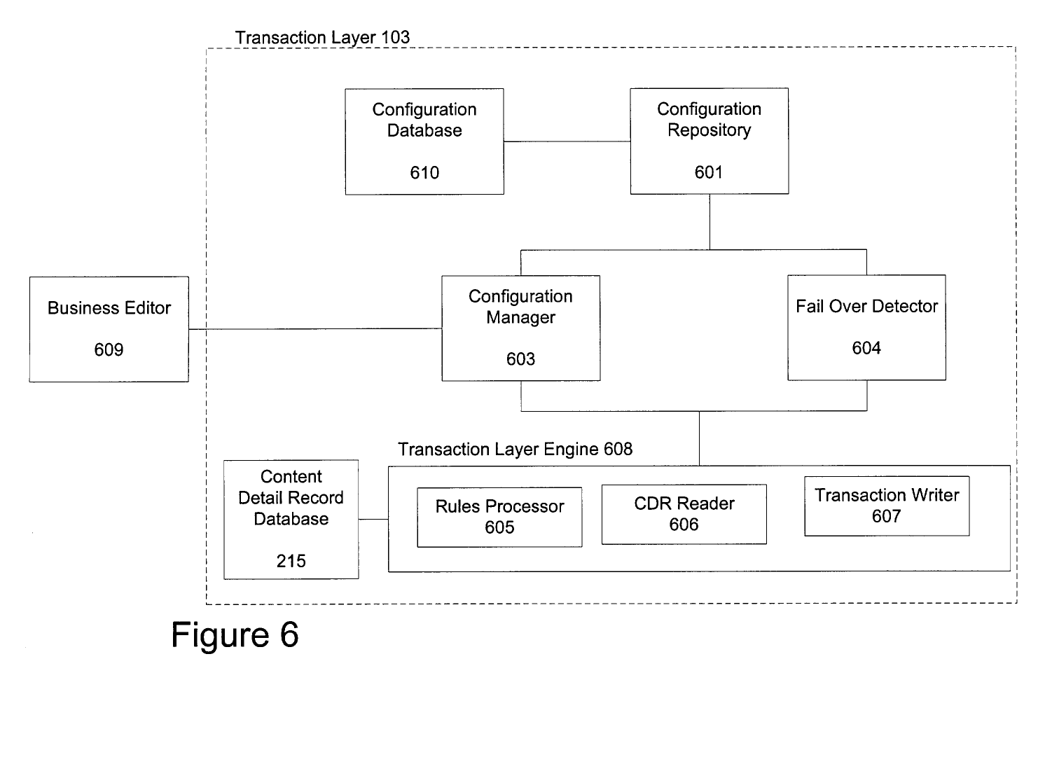

FIG. 6 is a block diagram further detailing the operation and configuration of transaction layer 103. It should be appreciated that elements described for transaction layer 103 are not exclusive, but provide just one example of a configuration for transaction layer 103. In particular, the functionality of the previously described ownership resolution component 216 and transaction resolution component 221 will be described in greater detail in the various components described with reference to FIG. 6. In practice, however, it should be appreciated that transaction layer 103 may comprise of any number of components that ensure that the necessary parties to a transaction are identified generically.

As shown in FIG. 6, transaction layer 103 includes a configuration repository 601, a configuration database 610, a configuration manager 603, and a fail over detector 604. In addition, transaction layer 103 includes a transaction layer engine 608 in communication with configuration repository 601, configuration manager 603, and fail over detector 604.

Transaction layer engine 608 includes a rules processor 605, a CDR reader 606, and a transaction writer 607. Transaction layer engine 608 processes raw data 204-206 in usage record 401 and creates a modified usage record 402, based upon the requirements of settlement layer 104. It should be appreciated that there may be more than one transaction layer engine 608 for each transaction layer 103. However, a single transaction layer engine 608 is shown for the purpose of clarity and brevity.

CDR reader 106 understands the nature of the transaction and operates to read a particular usage record 401 stored in CDR database 215. CDR reader 106 then submits usage record 401 to rules processor 605. Rules processor 605 applies rules (e.g., written in XML) to usage record 401 so as to determine ownership and the relationships among the ownership, for each individual usage record 401. Rules processor 605 may then generate one or more modified usage records 402, based on the application of the rules to usage record 401. Once rules processor 605 generates the modified usage record 402, transaction writer 607 operates to write a transaction (based on the modified usage record 402) to CDR database 215. Modified usage record 402 is then used by settlement layer 104 to further process the transaction (e.g., rate the transactions monetarily).

Fail over detector 604 operates to provide fault tolerance and initiate a fail over engine (not shown) for a failed transaction layer engine, in accordance with one or more mathematical algorithms, the discussion of which is beyond the scope of the invention. Configuration manager 603 provides an external interface to transaction layer 103 using a business editor 609. Business editor 609 may be manipulated by a user or customer using a graphics user interface (GUI). In particular, the GUI of business editor 609 receives commands from a user and translates them into actions to be performed on usage record 401, for example, by rules processor 605. Configuration repository 601 operates to provide an abstraction to configuration database 610. Configuration database 610 may be a relational database or a set of extensible markup language (XML) computer-readable files, for example.

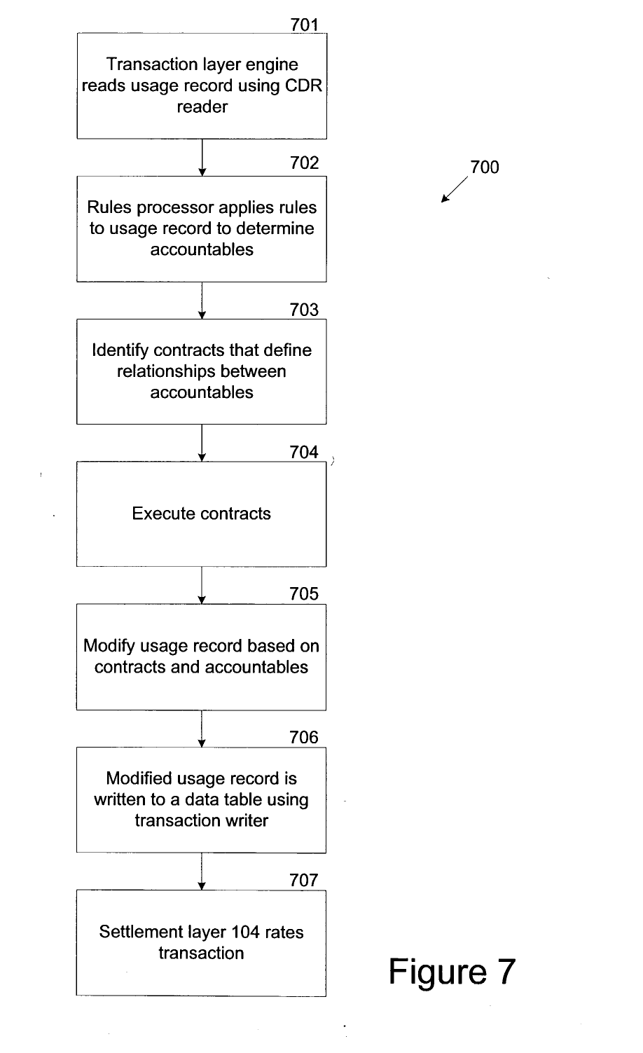

FIG. 7 is a flow diagram that details the operation of transaction layer 103, as shown in FIG. 6. As discussed, it should be appreciated that multiple transaction engines may be used to implement a process. Where the invention is instituted using computer-readable instruction, transaction layer engine 608 may be implemented as a computer-executable instruction or thread. Therefore, multiple transaction layer engines may be implemented by having multiple computer-readable instructions.

In step 701, transaction layer engine 608 reads usage record 401 using CDR reader 606. In step 702, rules processor 605 applies one or more rules to usage record 401 read by CDR reader 606, so as to determine one or more “accountables.” Accountables are labels that are used to facilitate identifying the parties or owners to a transaction. Accountables may be defined and/or modified by an external user (e.g., a customer) using the graphical user interface provided by business editor 609. Also, it should be appreciated that accountables may be defined for a new usage types for which no rules in rules processor 605 are provided. The identification of accountables is the function of ownership resolution component 216, as described with reference to FIG. 4.

In step 703, “contracts” are identified that define the relationships or agreements between one or more accountables. In the context of a billing system, a contract identifies which parties pays (i.e., the billed party) and which party receives payment (i.e., the billing party). A particular contract may be identified and executed when one or more “conditions” are satisfied. The identification of contracts is conducted by transaction resolution component 221, as described with reference to FIGS. 2 and 4. A condition is an expression of a logical assertion that can be evaluated as true or false. In transaction layer 103, for example, a condition may be true if a certain data element is present and false if the data element is not present. The following is an example of a condition in XML:

<condition name=“condition1” function=“Is Present” outcome=“true” type=“Accountable” id=“ColoProvider”/>

In step 704, once the contracts are determined, they are executed. In step 705, usage record 401 is changed to modified usage record 402 based upon the execution of the contract and the identification of the accountables. In step 706, modified usage record 402 may be written to a data table using transaction writer 607, so that settlement layer 104 can rate it, in step 707. Therefore, a transaction may be represented as modified usage record 402, where modified usage record may include the elements of usage record 401 in addition to the accountable and contract elements (e.g., fields 409-410 as discussed with reference to FIG. 4).

Although the discussion provided an example of a single contract and two accountables for a single usage record, it should be appreciated that many contracts and many accountables (i.e., and therefore many “transactions”) may be derived from a single usage record, because there may be multiple transactions implicated from a single usage record 401. For example, usage record 401 may involve three parties each having a contract with the other respective parties. In this example, therefore, there may be three separate contracts for a single usage record 401, and three individual accountables for each party or owner. Moreover, as will be explained below, the contracts may operate according to pricing plans that vary over time and from party to party.

In addition to requiring a certain accountable, it may be necessary to determine a value of the accountable. For example, transaction layer 103 may determine not only that the “called party” accountable be a part of the transaction, but also that a value for the called party (e.g., “856-555-1212” or “John Doe”) be identified. Also, it may be necessary to transform one accountable into another accountable to satisfy the requirement of settlement layer 104. For example, settlement layer 104 may require the called party accountable (either determined by transaction layer 103 or provided in usage record 401) be transformed into a network identifier accountable.

In either case, the value or transformation of accountables or contracts may be determined using certain predetermined functions or “primitives.” A primitive defines a transformation or a valuation of an accountable or contract. As discussed, transformations may allow a value of an accountable to be determined using another accountable, for example. Primitives define and direct such transformations. The input to a primitive can be one of fields 403-408 from usage record 401 or a previously determined accountable, for example.

Primitives may be described and distinguished based on their prescribed functionality. For example, one type of primitive may be a database lookup. A database lookup is a primitive that operates to transform one accountable or contract to another accountable or contract. Also, a database lookup primitive may function to assign a value to an accountable or contract, as a result of conducting a lookup of the accountable or contract in a database. It should be appreciated that the database lookup primitive also allows flexibility in that any database that has Java Database Connectivity (JDBC) drivers (e.g., Oracle, Microsoft SQL Server, Sybase, Database 2) can be used to perform complex lookups. In this way, therefore, previous accountable or contact transformations can be linked to find new accountables or contracts, respectively.

Other types of primitives may include direct value assignment, and a function primitive that looks up data in an external database. Other primitives may include a function primitive that it allows a third party based library (e.g., Java-based) to be used. Another primitive may be a “regular expression” based primitive that allows parsing of complex text-based fields with a full feature (e.g., PERL5 compliant) pattern specification. Common used techniques would include parsing URLs, filenames and paths, calling/called telephone numbers, email address, for example. In addition, a CDR database 215 lookup primitive allows holding on to an ownership entity if no further processing is required. This primitive is used where usage record 401 provides the information needed by settlement layer 104 without any need for more data correlation and/or manipulation by transaction layer 103.

A default primitive may be a hard-coded primitive that is used where the value is known and/or is not dependent on usage record 401. For example, such a primitive may be used where a party is always present in a consumption event, regardless of the other relevant parties. A network address primitive allows determination of a network entity given an arbitrary string. An area code primitive may be used to determine an area code of a telephone number given the complete telephone number. This primitive may be relevant for a Voice-over-IP application. These examples primitives are not exclusive, but are meant to provide a few examples of the manipulation and correlation that may be achieved by the primitives on the accountables and contracts.

The following is an example of an accountable primitive in XML:

<accountable>

<name>ColoProvider</name>

<role>ServiceProvider</role>

<usageType>RMONHost</usageType>

<valid from=“past” to=“present”/>

<primitive type=“default”>

<value>Exodus</value>

</primitive>

</accountable>

Each accountable that is involved in a contract will have an assigned “role.” It follows, therefore, that an accountable that is not involved in a contract may not need to have an assigned role. The role associates the particular accountable for integration with settlement layer 104.

Similar to the accountable, a contract is implemented using a set of primitives. The following is an example of a contract primitive in XML. In the example, a Web hosting scenario is present where a content provider (e.g., CNN) places content on one or more Web servers and pays a Web Hoster for doing so based on some predefined pricing plan.

In order to define the accountables, certain elements of usage record 401 may be assumed as follows: Web Hit Time, Web Server Name/IP address, Client IP address, bytes, Mime type, and URL. In this example, if a rule in the business world requires the “Content Provider” of the Web Server (e.g., CNN) to pay to the Web Hoster, there are two accountables: Web Hoster and Content Provider. The XML definition of a contract that captures this business rule may be as follows:

| | |
|---|---|
| 01 | <contract> |
| 02 | <name> ContentProvider-Pays-WebHoster </name> |
| 03 | <usageType> WebHosting </usageType> |
| 04 | <valid from=“past” to=“present” /> |
| 05 | <condition function=“IsPresent” type=“Accountable” |
| | name=“condition1” id=“ContentProvider” /> |
| 06 | <condition function=“IsPresent” type=“Accountable” |
| | name=“condition2” id=“WebHoster” /> |
| 07 | <billedFunction> |
| 08 | <status> enabled </status> |
| 09 | <primitive type=“internal-account-lookup”> |
| 10 | <database name=“GlobalDB”/> |
| 11 | <argument order=“1” type=“Accountable” |
| | name=“ContentProvider”/> |
| 12 | </primitive> |
| 13 | </billedFunction> |
| 14 | <billingFunction> |
| 15 | <status> disabled </status> |
| 16 | <primitive type=“internal-account-lookup”> |
| 17 | <database name=“GlobalDB”/> |
| 18 | <argument order=“1” type=“Accountable” |

name=“WebHoster”/>

| | |
|---|---|
| 19 | </primitive> |
| 20 | </billingFunction> |
| 21 | </contract> |

In this example, a contract has a name defined in line 02 as “ContentProvider-Pays-WebHoster.” The contract also defines an element or usage type called “WebHosting” in line 03. The contract also has two sets of conditions in lines 05 and 06, called “IsPresent,” which consider whether “ContentProvider” and “WebHoster” elements are present, respectively. Therefore, this particular contract will be selected and executed by transaction layer 103 if these elements are present.

Also, in this contract example, there are two primitives that are specified. There is a first primitive for finding the account number of the billed entity “ContentProvider,” which begins on line 07 and ends on line 13, and there is a primitive for determining the account of the billing entity “WebHoster” beginning on line 14 and ending on line 20. Therefore, the example contract contemplates the “who pays to whom” logic, and results in the execution of a contract that creates a modified usage record 402, which captures the transaction. Notably, in lines 09 and 16, both primitives are defined as database lookups.

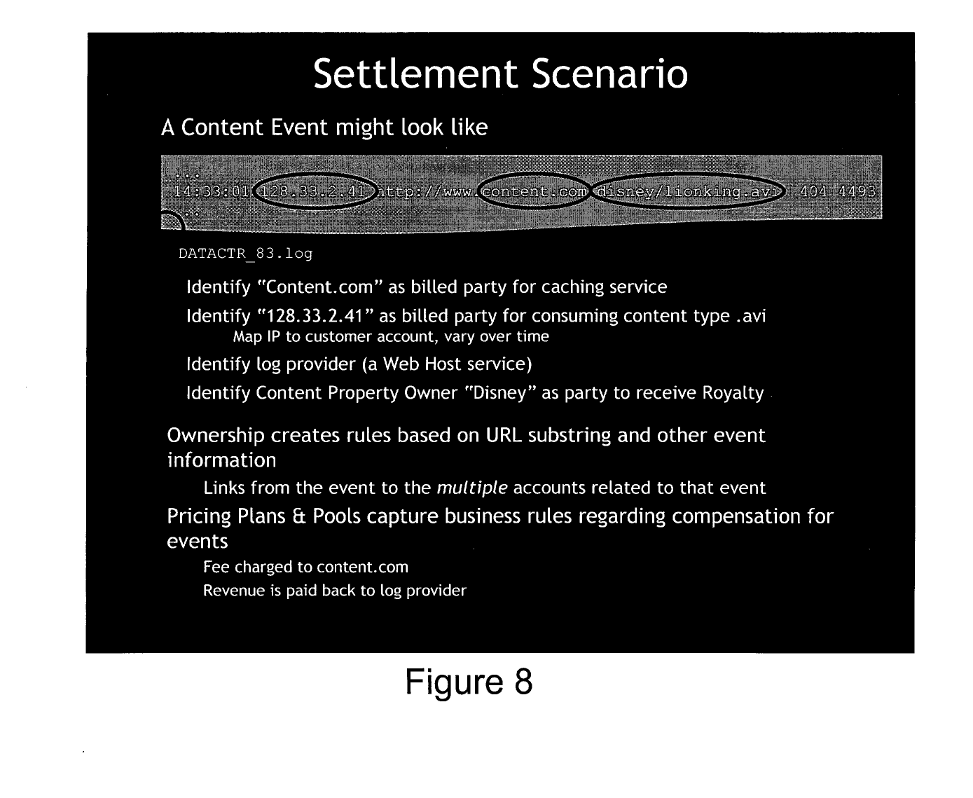

As noted above, to settle a transaction, the system must determine who should compensate whom and by how much. Many processes contribute to such “settlement.” Accordingly, the settlement layer 104 is not necessarily a particular logical component but may be spread throughout the system. In operation, a typical “settlement” might occur as described below with respect to FIG. 8.

FIG. 8 illustrates a sample content event as received by transaction layer 103 pursuant to the processes described above. In this example, “content.com” is identified as the billed party for a caching service, and IP address “128.33.2.41” is identified as the billed party for consuming content type “audio video interleave” (.avi). This IP address may be mapped to a customer account that may vary over time. The system also may identify the log provider (e.g., web host service) and may identify the content property owner (e.g., “Disney”) as the party to receive a royalty, or some other form of compensation, for the download. This ownership may create rules based on the unique resource locator (URL) substring and other event information. Also, links may be provided from the event to the multiple accounts related to that event. The use of pricing plans and pools, as described below, allow business rules to be captured regarding compensation for events, for example, in ways that greatly increase system flexibility. In this example, a fee may be charged to “content.com,” while revenue may be paid back to the log provider.

### Settlement of Transactions Subject to Multiple Pricing Plans

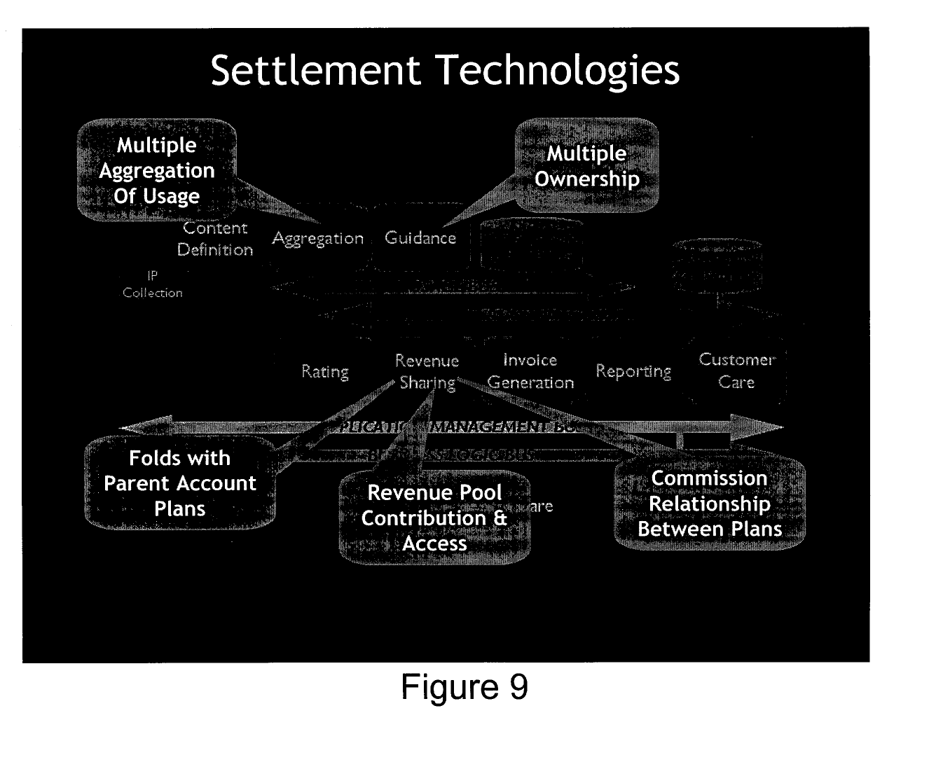

In many transactions, the accounts include one or more pricing plans that are customized to particular customers. As shown in FIG. 9, the settlement technologies used to settle such transactions may allow for multiple ownership of content, multiple aggregation of usage, and provide a variety of revenue sharing models. Several of such models will be described below including folds with parent account plans, revenue pooling, and commission relationships between plans.

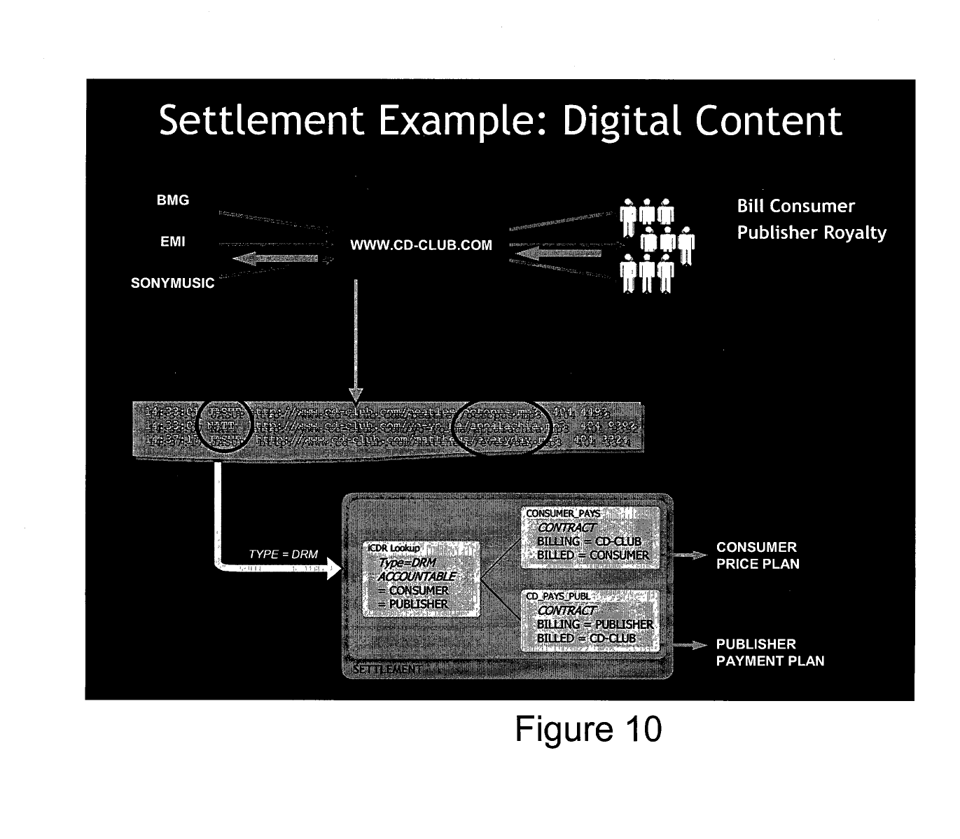

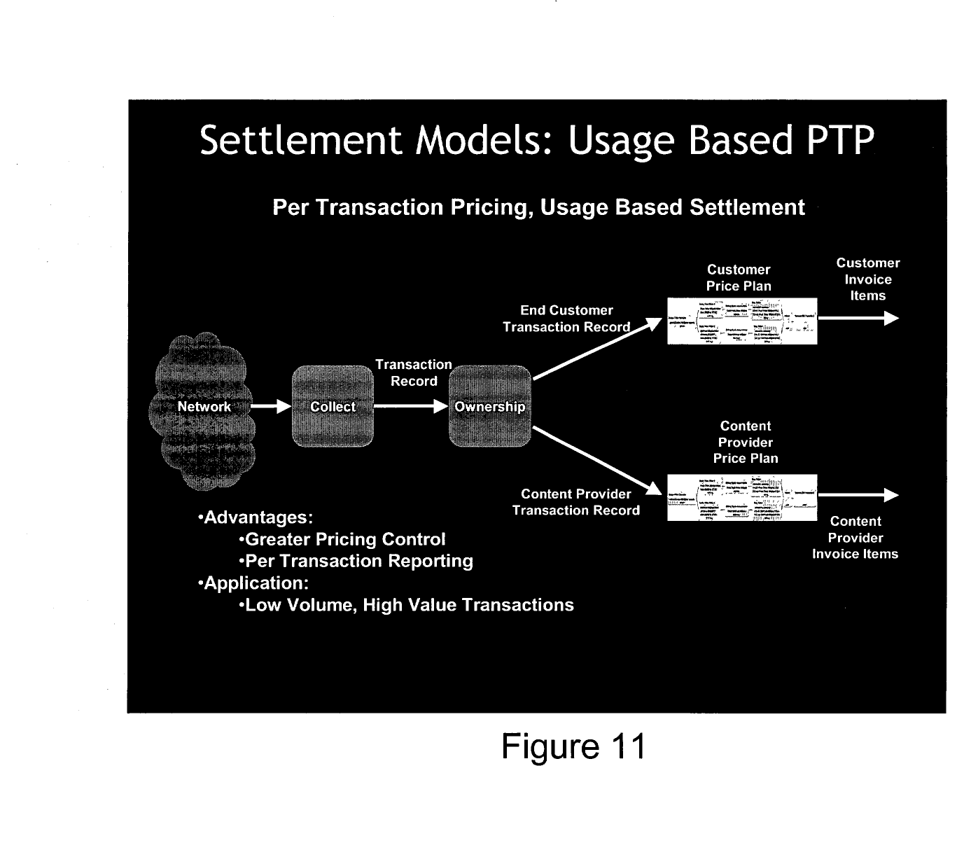

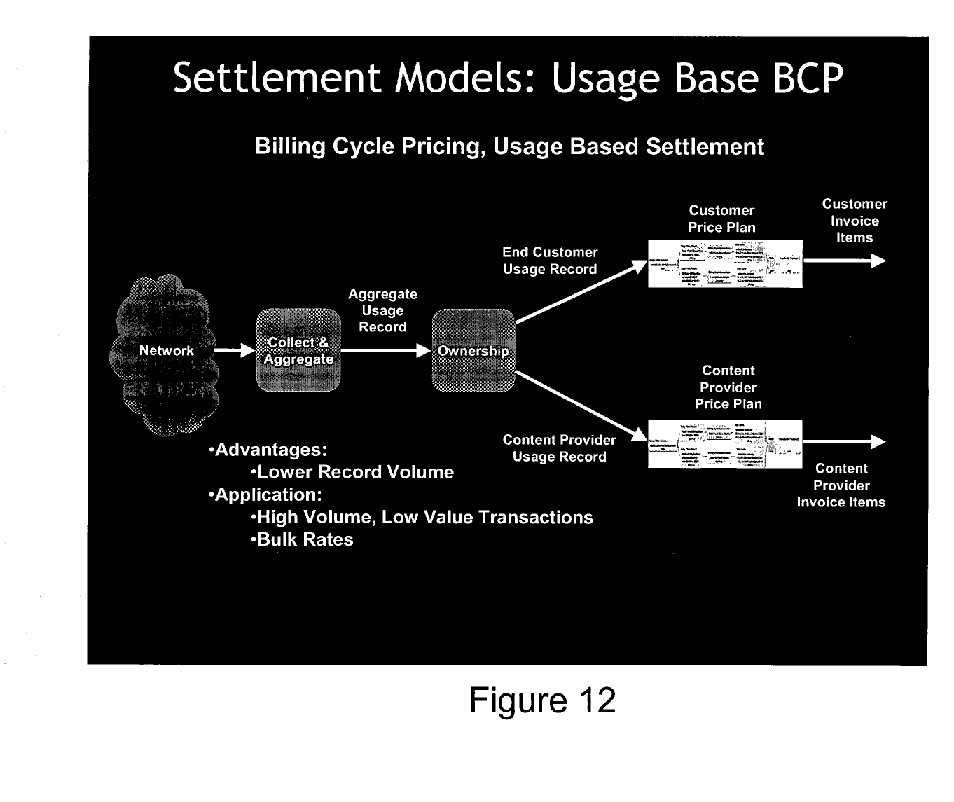

FIG. 10 illustrates a settlement example for the case of digital content, such as digital music content downloadable off of the Internet. In this example, an on-line music club (e.g., BMG, EMI, Sony) has a contractual relationship with the consumers as well as the music publishers (e.g., “www.cd-club.com”) and, at settlement, allocates payment according to the price plan(s) with the consumer and the payment plan(s) with the publishers. These payment plans recognize that each song may have a different price and that the revenue paid to the publisher, author, etc. may vary over time depending upon the frequency of download, for example. The price to the consumer also may vary with use. FIGS. 11 and 12 illustrate settlement models that take into account transaction pricing and billing cycle pricing for such usage based settlements. As those skilled in the art will appreciate, the per transaction usage based model may be best utilized for low volume, high value transactions, while the billing cycle pricing usage based model may be better for high volume, low value transactions.

The present invention allows for the networking of a multiplicity of pricing plans during rating process 217 in settlement layer 104. Thus, the system described below is implemented primarily in ratings 217 described above with respect to FIG. 2.

### Pricing Plan Overview

In accordance with the invention, pricing plans may be created by interconnecting rating building blocks with customizable properties. Each rating building block may be specialized in one well-defined function that falls roughly into five classes: usage selection and filtering, usage computation, accumulation, rate computation, and bill presentation. By interconnecting these rating building blocks, together with the ability to add new rating building blocks to the system, very flexible and extensible pricing plans can be created. The computation may be desirably constrained within one pricing plan.

A new class of rating building blocks also may be defined to extend the usefulness of pricing plans. This new class of rating building blocks allows a plan to access the states of another pricing plan or a group of pricing plans. These states can be usages and/or charges associated with line items and/or intermediate computations. With this new capability, computation is not constrained within one pricing plan but within a network of pricing plans working together. This new computation offers, but is not limited to, many settlement features.

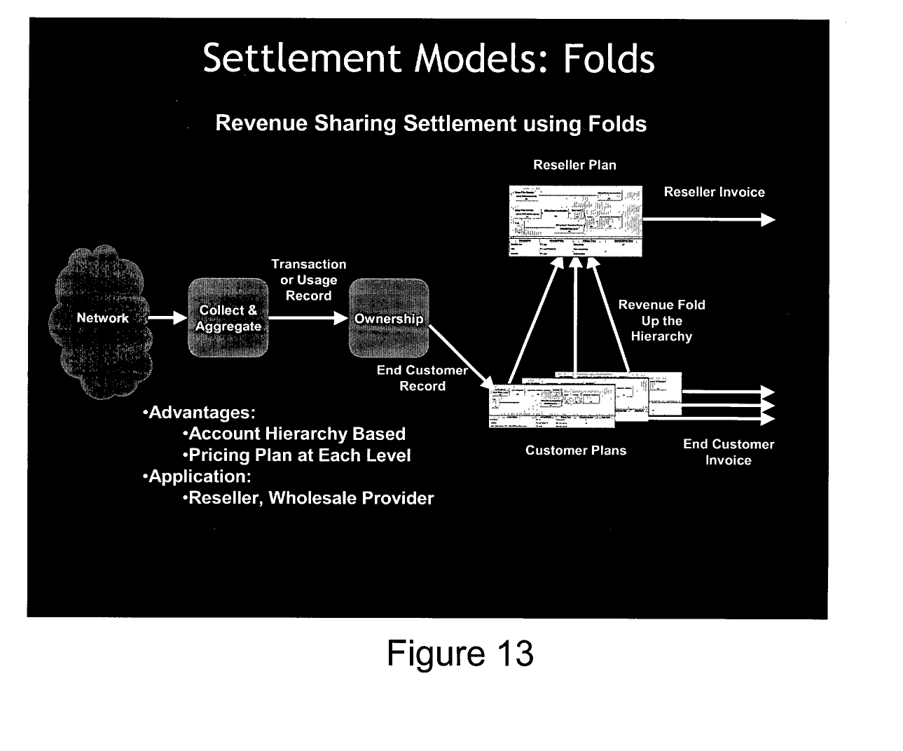

A revenue fold summarizes revenue, which is the output of a pricing plan, from child accounts and presents the folded revenue to their corresponding parent accounts as input to their pricing plans. This process may start from the lowest level and continue on up to the root level. The value of revenue fold may be available to a parent account in a pricing plan through a building block (e.g., “RevenueToDate”) As illustrated in FIG. 13, the revenue fold settlement model of the invention may provide for pricing plans at each level in the hierarchy and allow for the use of resellers.

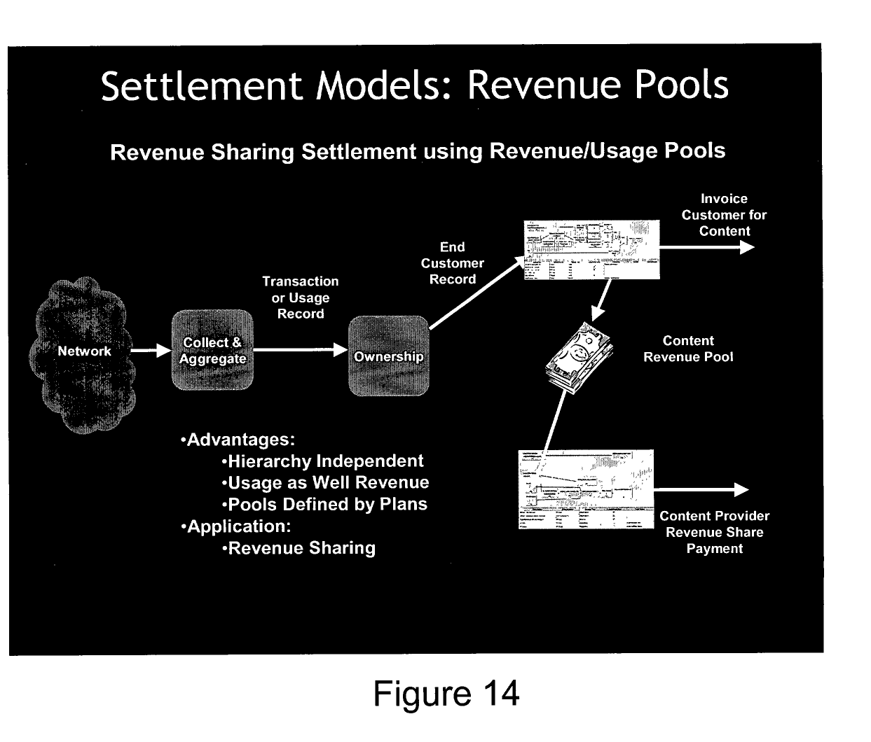

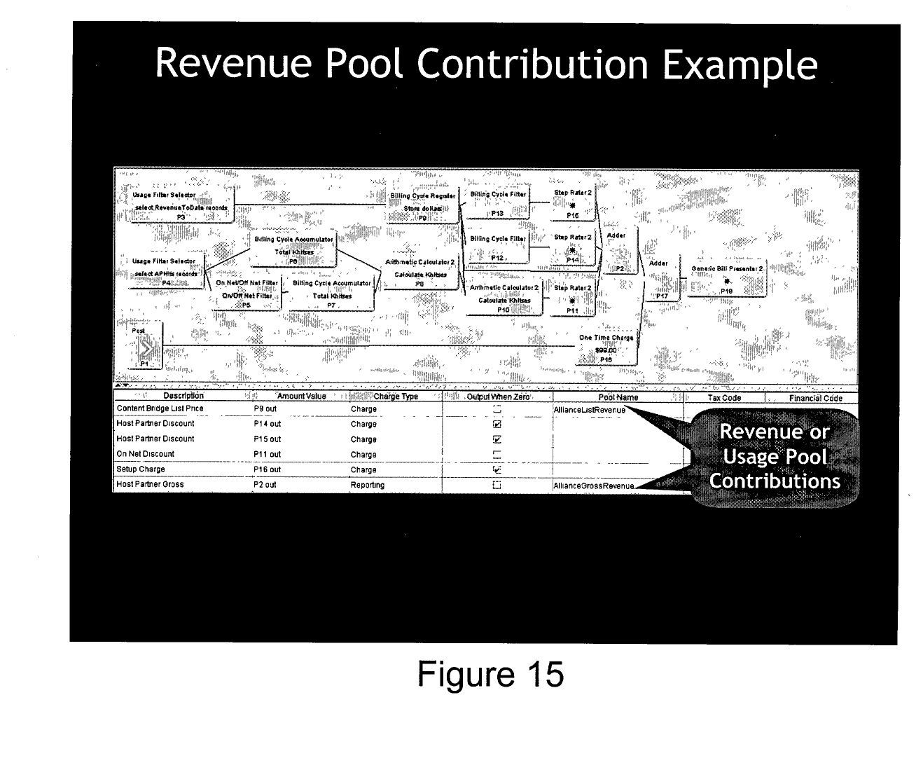

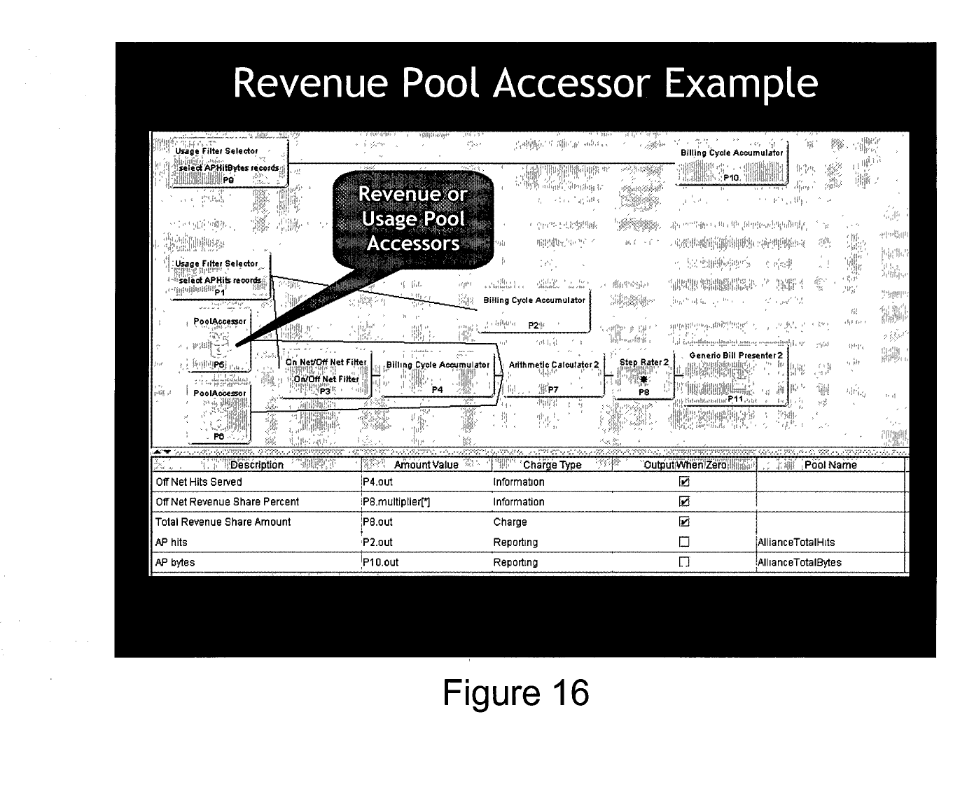

Revenue/usage pools are similar to global variables except that they include the concept of billing cycles. Different periods of a pool imply different instances and therefore different values. A pool value may be updated during invoice processing by summing the values of invoice line items associated with the pool from appropriate account plan periods. An account plan period is considered appropriate if the end date is within the period of the particular pool instance. Note that it is possible to have zero or more than one account plan periods from the same account to be included in the same pool instance. The computation of a pool value may not be cumulative between updates. When a pool value needs to be updated, the computation may start over with the previous value of a pool having no consequence. For example, the value of a pool may be accessible from a pricing plan through a building block (e.g., “PoolAccessor”) with the pool name as its property. The output of the “PoolAccessor” is the sum of the pool instances having the same pool name and billing period end dates within the start and end dates of the account plan period. As shown in FIG. 14, this settlement feature is useful in revenue sharing scenarios where total revenue and resources are pooled together and total revenue is shared among the contributing accounts based on contributed resources. The pools may be hierarchy independent and defined by the pricing plans. A revenue pool contribution example is given in FIG. 15, and a revenue pool accessor example is given in FIG. 16.

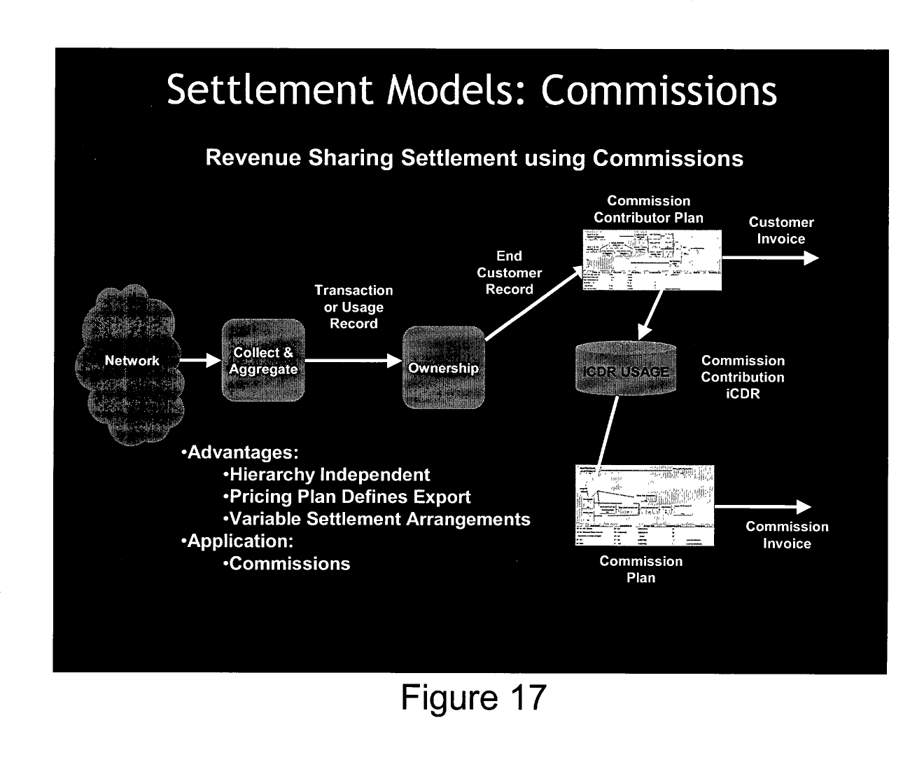

A commission is a credit given to an account. The credit amount is computed based on the revenue, or states of another account. The two accounts involved in the transaction are commission source account and commission destination account. As shown in FIG. 17, the commission source account (commission generator plan) generates the commission contribution iCDR using a building block (e.g., “CommissionGenerator”) with “AccountNumber” and “CommissionDescription” as its properties. The amount, not necessarily revenue, going into the CommissionGenerator (commission plan) is the commission amount. When used in conjunction with existing rating building blocks, commission features such as the following can be supported: commission going to multiple accounts, commission based on total revenue or a subset of the revenue (e.g., only monthly and usage charges, but not setup charges), commission for the first “n” billing period only (or different rate after first “n” periods), and step rate.

The commission destination account may receive the commission data through a building block (e.g., “CommissionAccumulator”). Additional commission features such as the following can be supported on the destination account: a recurring base commission, promotional commission rate, and step commission rate. The commission settlement model also may be hierarchy independent and permit variable settlement arrangements.

When computation involves a network of pricing plans, the correct output of a particular pricing plan may be dependent on the processing of another pricing plan. The output of the other pricing plan may in turn dependent on yet another pricing plan. A cyclic dependence can even exist. In order to have the correct computation for the network of pricing plans as a whole, the system detects and continues processing until all pricing plans reach their final values. Accordingly, the settlement processing software in accordance with the invention has a built-in mechanism to repeat processing of the pricing plans until their values are final. The algorithm will stop after a configurable loop count to prevent infinite processing in case there is a cyclic dependence.

### Billing Cycle Considerations

Because more than one account may be involved in settlement, it is possible that they have different billing periods. The following section details how each settlement feature is processed for the settlement models of the invention when accounts with different billing periods are involved.

Revenue fold summarizes revenue from child accounts and presents the folded revenue to their parent accounts. This process starts from the lowest level and continues up to the root level. In actual settlement processing, revenue fold is a post order traversal of a tree whose nodes are account plan periods, where a post order tree traversal traverses each sub tree of the root in post order followed by the root. The child account plan periods are selected if the end dates are within the parent's account plan period. It is possible to have zero or more than one account plan period from the same account included in one revenue fold. The root account's account plan period is defined by the invoice processing start and end dates.

An iCDR is generated for each revenue fold. The iCDR is rated by the pricing plan for the account plan period receiving the revenue fold. Therefore, pricing plans for non-leaf accounts take revenue fold into consideration. The value of revenue fold is available in a pricing plan through a building block (e.g., “RevenueToDate”).

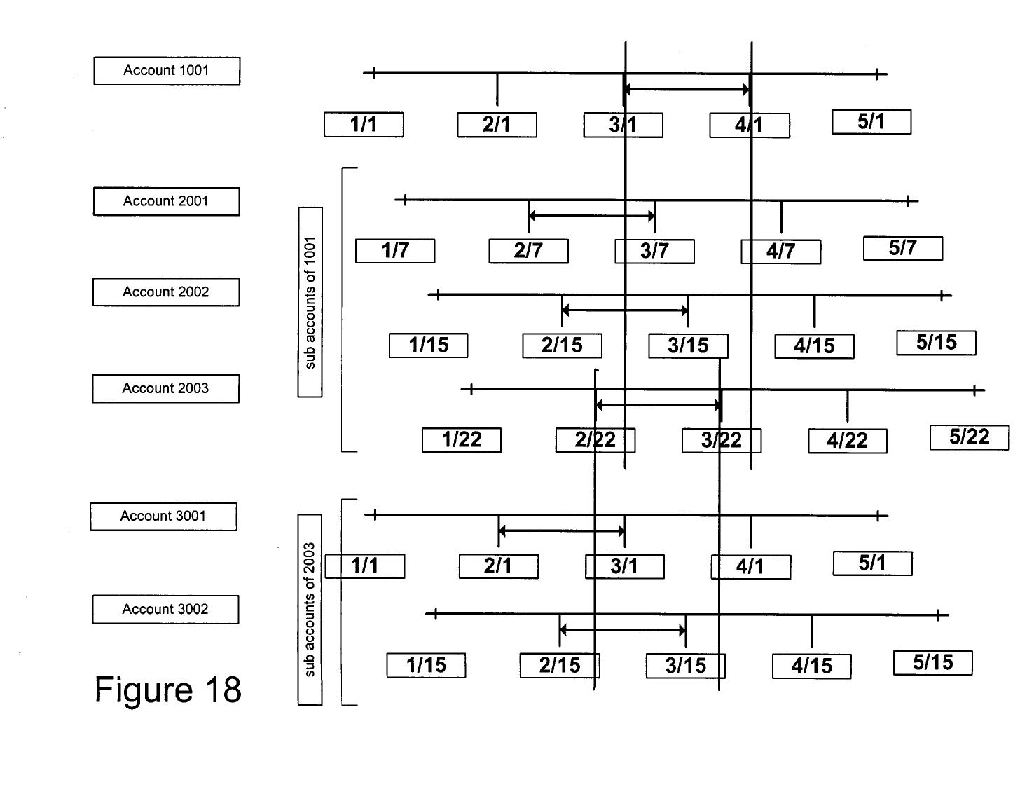

FIG. 18 provides an example of computing revenue fold. To compute the revenue fold for account 1001, the revenue from all child accounts of 1001 with account plan period end dates between 3/1 and 4/1 are summed. In this example, the revenue for account 2001 for the billing period 2/7 to 3/7, account 2002 for the billing period 2/15 to 3/15, account 2003 for the billing period 2/22 to 3/22 are summed. Before the summing of the revenue of these accounts can occur, their own revenues are determined. In order to determine the revenue of these child accounts, their child accounts with account plan period end dates between their account plan period start and end dates are selected and summed. The following example shows that to determine the revenue for account 2003 for the billing period 2/22 to 3/22, revenue for account 3001 for the billing period 2/1 to 3/1 and account 3002 for the billing period 2/15 to 3/15 are summed. This process repeats until the leaf level account is reached.

The value of a pool is accessible from a pricing plan through a rating building block (e.g., “PoolAccessor”). The output of “PoolAccessor” is the sum of the pool instances having billing period end dates within the start and end dates of the account plan period. It is possible to have zero or more than one instance selected given a particular account plan period depending on the billing period of the pool and the account. Therefore, given the same plan, “PoolAccessor” output may vary according to the account plan period. This technique ensures that each invoice line item associated with a pool will be included a pool instance and that each pool instance will be accessed once by an account which accesses the pool.

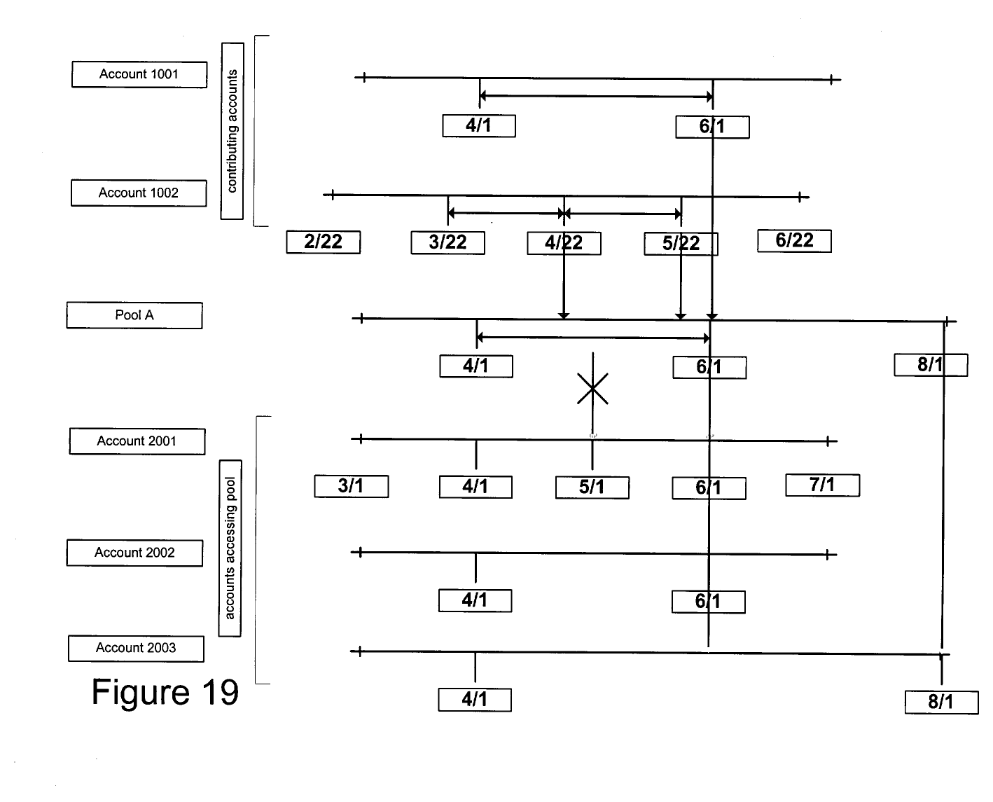

FIG. 19 illustrates how accounts and pools with different billing cycles contribute to and access from pool instances. For example, line items associated with pool A for account 1001 with billing period from 4/1 to 6/1 and account 1002 with billing periods from 3/22 to 4/22 and 4/22 to 5/22 will contribute to the pool A's instance with period from 4/1 to 6/1. The output of the PoolAccessor will be zero for account 2001 during the period 4/1 to 5/1. For billing period from 5/1 to 6/1, account 2001 will get the value of pool A's instance with period from 4/1 to 6/1. Account 2002 with billing period from 4/1 to 6/1 will also get pool A's 4/1 to 6/1 instance. The account plan period from 4/1 to 8/1 for account 2003 will get the sum of the two pool A's instances, 4/1 to 6/1 and 6/1 to 8/1.

During invoice processing, one or more iCDRs will be generated for each commission producing account plan periods. The generated record will have the destination account number, amount, and a timestamp. The timestamp is the end date of the account plan period that generated the record. The record will then be rated by the destination account in the appropriate account plan period.

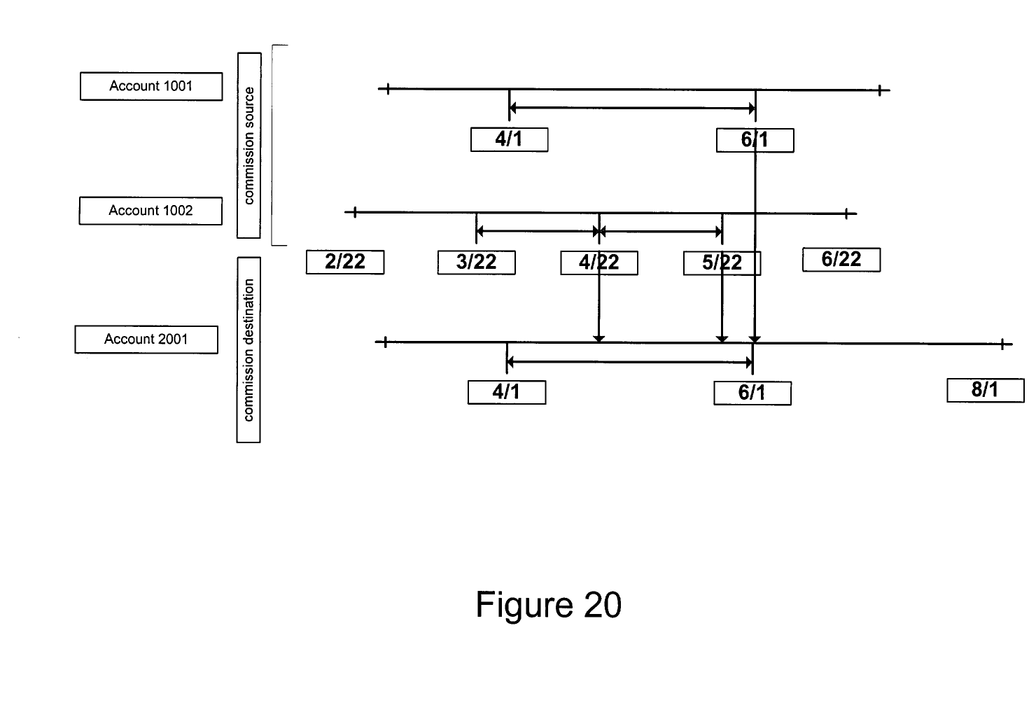

FIG. 20 provides an example of how an account 2001 with billing period ending 6/1 will get one commission from account 1001 for the period 4/1 to 6/1 and two commissions from account 1002 for the periods 3/22 to 4/22 and 4/22 to 5/22.

An invoice output may be dependent on the processing of settlement features. In turn, processing of settlement features may be dependent on correct invoice output. For example, if the pricing plan associated with an invoice accesses one or more pools, revenue/usage pool processing should be completed successfully before a correct invoice can be produced. To process a revenue/usage pool correctly, account plan periods associated with a pool have to produce a correct invoice that in turn may be dependent on revenue fold. There may not be a single, correct pre-defined order of processing for these settlement features. In some cases, the same settlement features may have to be processed more than once (e.g., revenue fold, generate commission and then revenue fold again).

The settlement processing has a built-in mechanism to repeat processing of the settlement features in a fixed sequence until the values are final. To prevent the algorithm from looping forever, there is a configurable maximum loop count. If the result is not final after the maximum loop count, a warning will be given, and the user may remove the circular dependency (if one exists) and/or increases the maximum loop count.

The invention described above is directed to a system and method for handling the networking of pricing plans in the settlement of transactions. The invention often was described in the context of the Internet, but is not so limited to the Internet, regardless of any specific description in the drawing or examples set forth herein. For example, the invention may be applied to wireless networks, as well as nontraditional networks like Voice-over-IP-based networks and/or private networks. It will be understood that the invention is not limited to the use of any of the particular components or devices herein. Indeed, this invention can be used in any application that requires aggregating data. Further, the system disclosed in the invention can be used with the method of the invention or a variety of other applications.

While the invention has been particularly shown and described with reference to the embodiments thereof, it will be understood by those skilled in the art that the invention is not limited to the embodiments specifically disclosed herein. Those skilled in the art will appreciate that various changes and adaptations of the invention may be made in the form and details of these embodiments without departing from the true spirit and scope of the invention as defined by the following claims.

What is claimed is:

1. A method of rating a transaction, comprising:
processing a transaction, wherein the transaction is processed when a service is provided from a service provider to a service consumer;
accessing via a computer network multiple pricing plans related to the transaction; and
rating the transaction in accordance with the multiple pricing plans.

2. The method of claim 1, wherein at least one of the pricing plans includes at least one of the following: revenue folds, revenue/usage pools, and commissions.

3. The method of claim 1, further comprising receiving output states from at least one pricing plan.

4. The method of claim 1, wherein the rating is accomplished within one pricing plan.

5. The method of claim 1, wherein the rating is accomplished within a group of pricing plans.

6. The method of claim 1, wherein the accessing is accomplished via interconnected building blocks located within each of the pricing plans.

7. The method of claim 1, wherein the building blocks perform at least one of the following functions: data usage selection and filtering, data usage computation, data accumulation, rate computation, and presentation of required payment.

8. The method of claim 6, wherein the building blocks have customizable properties.

9. The method of claim 6, wherein the building blocks allow a first pricing plan to access states of another pricing plan.

10. The method of claim 9, wherein the states are usages and charges associated with one or more pricing plans.

11. The method of claim 6, wherein the building blocks allow a first pricing plan to access the states of a group of pricing plans.

12. The method of claim 11, wherein the states are usages and charges associated with one or more pricing plans.

13. The method of claim 1, further comprising a revenue fold, wherein the revenue fold summarizes the output of multiple pricing plans.

14. The method of claim 13, wherein the revenue fold summarizes child accounts and inputs the summary information to pricing plans of corresponding parent accounts.

15. The method of claim 13, wherein the value of the revenue fold is available to the pricing plan via a building block.

16. The method of claim 13, wherein the revenue fold is available to child and parent accounts.

17. The method of claim 13, further comprising selecting child accounts with end dates that are within a parent account's time period.

18. The method of claim 1, further comprising pooling revenue/usage data as a function of billing cycles.

19. The method of claim 18, further comprising updating the pooled revenue/usage data by summing the values of data from selected account plan periods.

20. The method of claim 18, further comprising selecting the account plan period as a function of the end date of the account plan with respect to the pooled revenue/usage data.

21. The method of claim 18, further comprising accessing a value of the pooled revenue/usage data via a building block.

22. The method of claim 1, further comprising determining a commission, wherein the commission is a credit given to an account.

23. The method of claim 22, wherein the credit is a function of at least one of the following: revenue, and states of another account.

24. The method of claim 22, wherein the determining of commission includes at least one of the following: commissions going to multiple accounts, a commission based on total revenue, a commission based on a subset of the, a commission for a first predetermined number of billing periods, a recurring base commission, a promotional commission rate, and step commission rate.

25. The method of claim 1, further comprising determining the value of a pricing plan as a function of another pricing plan.

26. The method of claim 25, further comprising providing a configurable loop count.

27. A method for providing extensible ratings plans, comprising:
determining the nature of a transaction over a computer network;
accessing over a computer network one or more pricing plans, wherein the pricing plans designate payment required by a user; and
providing one or more payment plans, wherein the payment plans designate payment to a provider of data.

28. The method of claim 27, further comprising customizing the payment plan to a particular customer.

29. The method of claim 27, wherein the data has multiple owners.

30. The method of claim 27, further comprising varying the payment plan over time.

31. The method of claim 27, further comprising varying the price of the payment plan.

32. The method of claim 27, further comprising varying the payment plan as a function of usage of the data.

33. The method of claim 27, further comprising varying the pricing plan over time.

34. The method of claim 27, further comprising varying the price of the pricing plan.

35. The method of claim 27, further comprising varying the pricing plan as a function of usage of the data.

36. The method of claim 27, further comprising rating the transaction on a per usage basis for low volume, high value transactions.

37. The method of claim 27, further comprising rating the transaction on a billing cycle usage basis for low volume, high value transactions.

38. A computer system for rating a transaction, comprising:
an instrumentation layer for receiving raw data;
a content collection layer for processing the raw data and for providing information related to a transaction over a computer network;
a transaction layer for determining parties to the transaction and for determining the burdens and benefits of the transaction to the parties; and
a settlement layer for rating the transaction by accessing via the computer network multiple pricing plans related to the transaction, and rating the transaction in accordance with the multiple pricing plans.

39. A computer-readable medium having computer-executable instructions, comprising:
processing a transaction, wherein the transaction is processed when a service is provided from a service provider to a service consumer;
accessing via a computer network multiple pricing plans related to the transaction; and
rating the transaction in accordance with the multiple pricing plans.

40. The computer-readable medium of claim 39, having computer-executable instructions further comprising receiving output states from at least one pricing plan.

41. The computer-readable medium of claim 39, having computer-executable instructions further comprising a revenue fold, wherein the revenue fold summarizes the output of multiple pricing plans.

42. The computer-readable medium of claim 39, having computer-executable instructions further comprising selecting child accounts with end dates that are within a parent account's time period.

43. The computer-readable medium of claim 39, having computer-executable instructions further comprising pooling revenue/usage data as a function of billing cycles.

44. The computer-readable medium of claim 43, having computer-executable instructions further comprising updating the pooled revenue/usage data by summing the values of data from selected account plan periods.

45. The computer-readable medium of claim 43, having computer-executable instructions further comprising selecting the account plan period as a function of the end date of the account plan with respect to the pooled revenue/usage data.

46. The computer-readable medium of claim 43, having computer-executable instructions further comprising accessing a value of the pooled revenue/usage data via a building block.

47. The computer-readable medium of claim 39, having computer-executable instructions further comprising determining a commission, wherein the commission is a credit given to an account.

48. The computer-readable medium of claim 39, having computer-executable instructions further comprising determining the value of a pricing plan as a function of another pricing plan.

49. The computer-readable medium of claim 48, having computer-executable instructions further comprising providing a configurable loop count.
